(19) United States
(12) Patent Application Publication
(10) Pub. No.: US 2019/0283872 A1
(43) Pub. Date: Sep. 19, 2019

(54) Medivac drone 1000

(71) Applicant: James Houston, Fort Worth, TX (US)

(72) Inventor: James Houston, Fort Worth, TX (US)

(21) Appl. No.: 15/922,824

(22) Filed: Mar. 15, 2018

(51) Int. Cl. B64C 39/02; B64D 9/00

(52) U.S. Cl. CPC B64C 39/024; B64D 9/00; B64C 2201/042; B64C 2201/146; B64C 2201/108; B64C 2201/141; B64C 2201/128

(57) ABSTRACT

Here's the specs:
gyroscopic self balancing technology included for transporting unconscious patients
GPS enabled autonomous technology for pre-directed pick up n delivery points
Self driving tech for object avoidance in-flight and during landing
Retractable n expandable for compact fight delivery—stretcher-ish, open for patient or send already open
Low center of gravity design for stability—“sling type”
Rider Self start operation if needed
12 to 16 or more, electric dronerotor motors 2-3 per corner, 2 or more per mid-side point for center lift
Battery—solid lithium ion moldable material doubles a power pack and unit body
Weight limits, range calculation performed pre-return flight, destination selection screen
Rigid foam type molded body with polymer layers & coating for strength w/integrated battery technology
Touch screen GPS rcuting buttons, “INPUT NEW DESTINATION, RETURN HOME, REROUTE, STOP”
Recharging station configuration for domestic and foreign current conversion charging

### BRIEF SUMMARY OF INVENTION

MVD 1000, Medivac Drone

For application in civil and military situations where an autonomous drone capable of providing safe evacuation of an unconscious patient from one location to another could save lives. This drone would be capable of pre-measuring time and distance capabilities once a patient's information is entered or, by the patient simply being secured into the vehicle. Options displayed in real-time and on-screen for potential destinations for patient delivery based on their weight, the power charge available and local wind or weather data. Destinations can be chosen or pre-programmed by the sender or operated remotely by mobile device/cell phone, etc.

This is not a long distance transport device. Trips will be measure in 100's of yards or portions of a mile to remove the patient from immediate danger.

Unique design features are the low-center of gravity design, the fiber/foam, flame-free battery material for the frame construction, the autonomous flying features that ensure patient safety.

The flexibility of having a smaller, portable evacuation vehicle could save many lives by simply removing from an immediate danger ie., tall buildings, restricted battlefield positions, flooded areas, locations blocked by fire or debris just to name a few applications.

### BACKGROUND

Unless otherwise indicated herein, the materials described in this section are not prior art to the claims in this application and are not admitted to be prior art by inclusion in this section.

An unmanned vehicle, which may also be referred to as an autonomous vehicle, is a vehicle capable of travel without a physically-present human operator. An unmanned vehicle may operate in a remote-control mode, in an autonomous mode, or in a partially autonomous mode.

When an unmanned vehicle operates in a remote-control mode, a pilot or driver that is at a remote location can control the unmanned vehicle via commands that are sent to the unmanned vehicle via a wireless link. When the unmanned vehicle operates in autonomous mode, the unmanned vehicle typically moves based on pre-programmed navigation waypoints, dynamic automation systems, or a combination of these. Further, some unmanned vehicles can operate in both a remote-control mode and an autonomous mode, and in some instances may do so simultaneously. For instance, a remote pilot or driver may wish to leave navigation to an autonomous system while manually performing another task, such as operating a mechanical system for picking up objects, as an example.

Various types of unmanned vehicles exist for various different environments. For instance, unmanned vehicles exist for operation in the air, on the ground, underwater, and in space. Unmanned vehicles also exist for hybrid operations in which multi-environment operation is possible. Examples of hybrid unmanned vehicles include an amphibious craft that is capable of operation on land as well as on water or a floatplane that is capable of landing on water as well as on land. Other examples are also possible.

### SUMMARY

In one aspect, an exemplary computer-implemented method may involve a computing device: (a) identifying a remote medical situation; (b) determining a target location corresponding to the medical situation; (c) and causing the UAV to travel to the target location to provide medical evacuation transport.

In a further aspect, a non-transitory computer readable medium may have stored therein instructions that are executable to cause a computing system to perform functions comprising: (a) identifying a remote medical situation; (b) determining a target location corresponding to the medical situation; (c) causing the UAV to travel to the target location to provide medical evacuation transport.

In another aspect, a medical-support system may include at least one non-transitory computer readable medium in at least one component of the system, and program instructions stored in the at least one non-transitory computer readable medium and executable by at least one processor to: (a) identify a remote medical situation; (b) determine a target location corresponding to the medical situation; (c) cause the UAV to travel to the target location to provide medical evacuation transport.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIGS. 1, 2, are simplified illustrations & descriptions of unmanned aerial vehicles adapted for the purposes of emergency patient evacuation, according to example embodiments.

### DETAILED DESCRIPTION

Exemplary methods and systems are described herein. It should be understood that the word “exemplary” is used herein to mean “serving as an example, instance, or illustration.” Any embodiment or feature described herein as “exemplary” or “illustrative” is not necessarily to be construed as preferred or advantageous over other embodiments or features. More generally, the embodiments described herein are not meant to be limiting. It will be readily understood that certain aspects of the disclosed systems and methods can be arranged and combined in a wide variety of different configurations, all of which are contemplated herein.

I. Overview

Embodiments described herein may relate to and/or may be implemented in a system in which unmanned vehicles, and in particular, “unmanned aerial vehicles” (UAVs), are configured to provide medical transport.

In an illustrative embodiment, a medical transport system may include a fleet of UAVs that are distributed throughout a geographic area, such as a city or military theatre. The medical-transport drone may be configured for communications with remote devices, such as mobile phones, so that medical support can be requested by a person in need of such medical transport (or by others on behalf of a person in need). The medical-transport system can then dispatch the unit to the scene of the medical situation in order to provide medical transport.

It should be understood that the above embodiments, and other embodiments described herein, are provided for explanatory purposes, and are not intended to be limiting.

Further, the term “medical situation” as used herein should be understood to include any situation to which government or private entity, such as a police department, a fire department, and/or an emergency medical services (EMS) entity, or military combat situation where emergency medical evacuation might be needed. Attributes described herein can also apply in non-medical and/or non-emergency applications also.

II. Illustrative Unmanned Vehicles

The term “unmanned aerial vehicle,” as used in this disclosure, refers to any autonomous or semi-autonomous vehicle that is capable of performing some functions without a physically-present human pilot. Examples of flight-related functions may include, but are not limited to, sensing its environment or operating in the air without a need for input from an operator, among others.

A UAV may be autonomous or semi-autonomous. For instance, some functions could be controlled by a remote human operator, while other functions are carried out autonomously. Further, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another (e.g., from Keller to Watauga Texas, about a mile), while the UAV's navigation system autonomously controls more fine-grained navigation decisions, such as the specific route to take between the two locations, specific flight controls to achieve the route and avoid obstacles while navigating the route, and so on. Other examples are also possible.

A UAV can be of various forms. For example, a UAV may take the form of a rotorcraft such as a helicopter or multicopter, a fixed-wing aircraft, a jet aircraft, a ducted fan aircraft, a lighter-than-air dirigible such as a blimp or steerable balloon, a tail-sitter aircraft, a glider aircraft, and/or an ornithopter, among other possibilities. Further, the terms “drone”, “unmanned aerial vehicle system” (“UAVS”), or “unmanned aerial system” (“UAS”) may also be used to refer to a UAV.

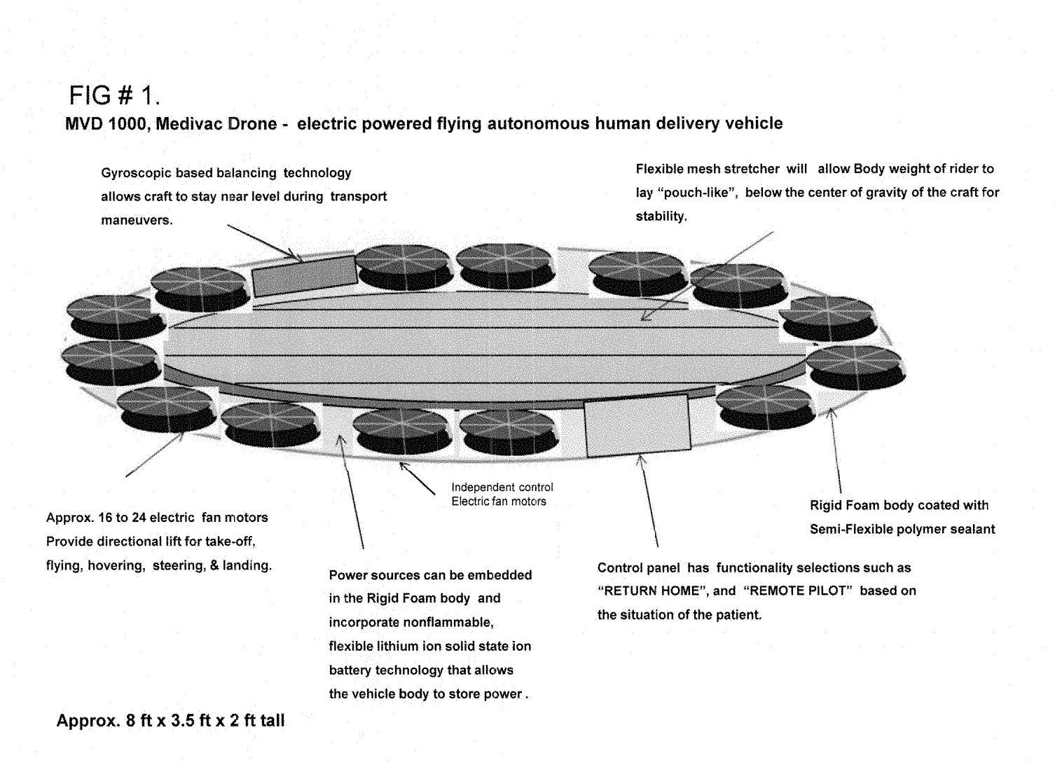

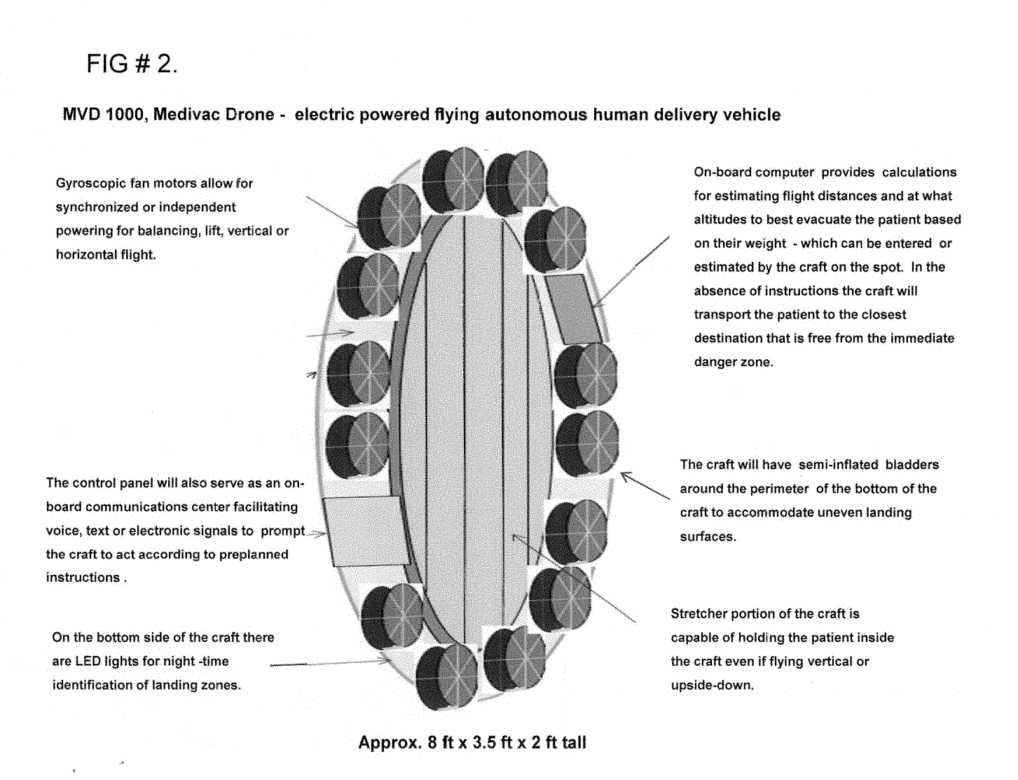

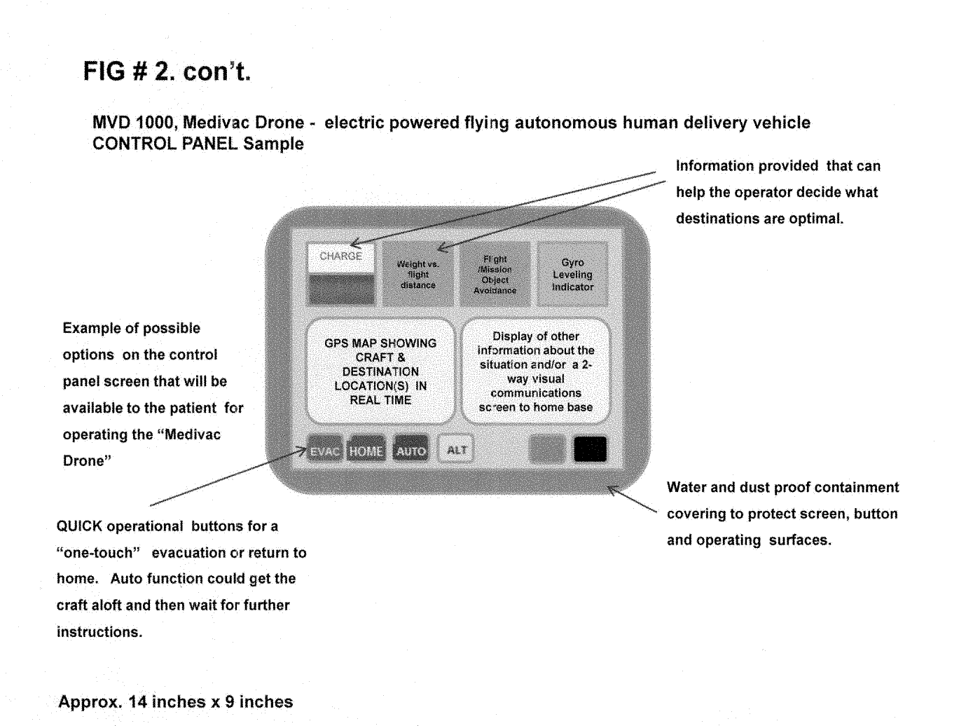

FIG. 1 is a simplified illustration of the Medivac Drone 1000 UAV unit, a.k.a MVD 1000, according to an example embodiment. In particular, FIG. 1 shows an example of a the MediVac Drone 1000 that is similar to a multicopter. Multicopters, also be referred to as a quadcopters, as it includes four rotors. It should be understood that example embodiments may involve rotorcraft with more or less rotors than multicopter. For example, a helicopter typically has two rotors. Other examples with three or more rotors are possible as well. Herein, the term “multicopter” refers to any rotorcraft having more than two rotors, and the term “helicopter” refers to rotorcraft having two rotors.

Referring to MediVac Drone 1000 in greater detail, the 10 or twelve rotors or more provide propulsion and maneuverability for the unit. More specifically, each rotor includes blades that are attached to a motor. Configured as such the rotors may allow the MediVac Drone 1000 to take off and land vertically, to maneuver in any direction, and/or to hover. Furthermore, the pitch of the blades may be adjusted as a group and/or differentially, and may allow the unit to perform three-dimensional aerial maneuvers such as a stable, level right side up hover, a continuous tail-down “tic-toc,” pirouettes, stall-turns with pirouette, knife-edge, and traveling flips, among others. When the pitch of all blades is adjusted to perform such aerial maneuvering, this may be referred to as adjusting the “collective pitch” of the unit. Blade-pitch adjustment may be particularly useful for rotorcraft with substantial inertia in the rotors and/or drive train, but is not limited to such rotorcraft

Additionally or alternatively, the unit may propel and maneuver itself adjust the rotation rate of the motors, collectively or differentially. This technique may be particularly useful for small electric rotorcraft with low inertia in the motors and/or rotor system, but is not limited to such rotorcraft.

The MedVac Drone 1000 also includes a central enclosure with straps to secure the patient in the unit. The central enclosure may contain, e.g., control electronics such as an inertial measurement unit (IMU) and/or an electronic speed controller, batteries, other sensors, and/or a payload, among other possibilities.

The illustrative MVD 1000 also includes landing gear to assist with controlled take-offs and landings. In other embodiments, multicopters and other types of UAVs without landing gear are also possible.

In a further aspect, MVD 1000 includes rotor protectors. Such rotor protectors can serve multiple purposes, such as protecting the rotors from damage if the multicopter strays too close to an object, protecting the multicopter structure from damage, and protecting nearby objects from being damaged by the rotors. It should be understood that in other embodiments, multicopters and other types of UAVs without rotor protectors are also possible. Further, rotor protectors of different shapes, sizes, and function are possible, without departing from the scope of the invention.

A multicopter may control the direction and/or speed of its movement by controlling its pitch, roll, yaw, and/or altitude. To do so, multicopter may increase or decrease the speeds at which the rotors spin. For example, by maintaining a constant speed of three rotors 9 or 11 and decreasing the speed of a any number of other rotors it can roll right, roll left, pitch forward, or pitch backward, depending upon which motor has its speed decreased. Specifically, the multicopter may roll in the direction of the motor with the decreased speed. As another example, increasing or decreasing the speed of all rotors simultaneously can result in the multicopter increasing or decreasing its altitude, respectively. As yet another example, increasing or decreasing the speed of rotors that are turning in the same direction can result in the multicopter performing a yaw-left or yaw-right movement. These are but a few examples of the different types of movement that can be accomplished by independently or collectively adjusting the RPM and/or the direction that rotors are spinning.

MVD 1000 may include various types of sensors, and may include a computing system configured to provide the functionality described herein. In the illustrated embodiment, the sensors may include an inertial measurement unit, ultrasonic sensor(s), GPS imaging system(s), among other possible sensors and sensing systems.

In the illustrated embodiment, MVD 1000 also includes one or more processors. A processor may be a general-purpose processor or a special purpose processor (e.g., digital signal processors, application specific integrated circuits, etc.). The one or more processors can be configured to execute computer-readable program instructions that are stored in the data storage and are executable to provide the functionality of a MVD 1000 as described herein.

FIG. 3. Sensory Description List

In an illustrative embodiment, may include both an accelerometer and a gyroscope, which may be used together to determine the orientation of the unit. In particular, the accelerometer can measure the orientation of the vehicle with respect to earth, while the gyroscope measures the rate of rotation around an axis. IMUs are commercially available in low-cost, low-power packages. For instance, a sensor may take the form of or include a miniaturized MicroElectroMechanical System (MEMS) or a NanoElectroMechanical System (NEMS). Other types of sensors may also be utilized.

A MVD 1000 may also include a pressure sensor or barometer, which can be used to determine the altitude of the unit. Alternatively, other sensors, such as sonic altimeters or radar altimeters, can be used to provide an indication of altitude, which may help to improve the accuracy of and/or prevent drift of the unit.

In a further aspect, it may include one or more sensors that allow the UAV to sense objects in the environment. For instance, in the illustrated embodiment, includes ultrasonic sensor(s), ultrasonic sensor(s) that can determine the distance to an object by generating sound waves and determining the time interval between transmission of the wave and receiving the corresponding echo off an object. A typical application of an ultrasonic sensor for unmanned vehicles or IMUs is low-level altitude control and obstacle avoidance. An ultrasonic sensor can also be used for vehicles that need to hover at a certain height or need to be capable of detecting obstacles. Other systems can be used to determine, sense the presence of, and/or determine the distance to nearby objects, such as a light detection and ranging (LIDAR) system, laser detection and ranging (LADAR) system, and/or an infrared or forward-looking infrared (FLIR) system, among other possibilities.

MVD 1000's also includes a GPS receiver. The GPS receiver may be configured to provide data that is typical of well-known GPS systems, such as the GPS coordinates of the unit. Such GPS data may be utilized by the unit for various functions. For example, when a caller uses a mobile device to request medical support from a UAV, the mobile device may provide its GPS coordinates. As such, the UAV may use its GPS receiver to help navigate to the caller's location, as indicated, at least in part, by the GPS coordinates provided by their mobile device. Other examples are also possible.

The MVD 1000 may also include one or more imaging system(s). For example, one or more still and/or video cameras may be utilized by a a unit to capture image data from the UAV's environment. As a specific example, charge-coupled device (CCD) cameras or complementary metal-oxide-semiconductor (CMOS) cameras can be used with unmanned vehicles. Such imaging sensor(s) have numerous possible applications, such as obstacle avoidance, localization techniques, ground tracking for more accurate navigation (e.g., by applying optical flow techniques to images), video feedback, and/or image recognition and processing, among other possibilities.

In a further aspect, the unit may use its one or more imaging system to help in determining location. For example, it may capture imagery of its environment and compare it to what it expects to see in its environment given current estimated position (e.g., its current GPS coordinates), and refine its estimate of its position based on this comparison.

In a further aspect, may include one or more microphones. Such microphones may be configured to capture sound from the UAVs environment.

Navigation and Location Determination

The navigation module may provide functionality that allows the unit to, e.g., move about in its environment and reach a desired location. To do so, the navigation module may control the altitude and/or direction of flight by controlling the mechanical features of the UAV that affect flight).

In order to navigate the unit to a target location, a navigation module may implement various navigation techniques, such as map-based navigation and localization-based navigation, for instance. With map-based navigation, the unit may be provided with a map of its environment, which may then be used to navigate to a particular location on the map. With localization-based navigation, the unit may be capable of navigating in an unknown environment using localization. Localization-based navigation may involve a unit building its own map of its environment and calculating its position within the map and/or the position of objects in the environment. For example, as a unit moves throughout its environment, it may continuously use localization to update its map of the environment. This continuous mapping process may be referred to as simultaneous localization and mapping (SLAM). Other navigation techniques may also be utilized.

In some embodiments, the navigation module may navigate using a technique that relies on waypoints. In particular, waypoints are sets of coordinates that identify points in physical space. For instance, an air-navigation waypoint may be defined by a certain latitude, longitude, and altitude. Accordingly, unit navigation module may cause it to move from waypoint to waypoint, in order to ultimately travel to a final destination (e.g., a final waypoint in a sequence of waypoints).

Communication Systems

In a further aspect, MVD 1000 includes one or more communication systems. The communications systems may include one or more wireless interfaces and/or one or more wireline interfaces, which allow it to communicate via one or more networks.

Such wireless interfaces may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network.

Power Systems

In a further aspect, MVD 1000 may include power system(s). A power systems may include one or more batteries for providing power to the unit. In one example, the one or more batteries may be rechargeable and each battery may be recharged via a wired connection between the battery and a power supply and/or via a wireless charging system, such as an inductive charging system that applies an external time-varying magnetic field to an internal battery. Another battery power system can built in to body of unit as in “embedded” into the foam plastic materials shaped to hold the propulsion mechanisms, controls and patient.

Medical-Transport Functionality

As noted above, MVD 1000 may include one or more medical-transport configurations. The one or more medical-support modules including software, firmware, and/or hardware that may help to provide or assist in the provision of the medical-support functionality described herein.

Configured as such, provide medical support in various ways. For instance, it may have stored information that can be provided to a person or persons at the target location, in order to assist the. For example, a UAV may provide a text-based interface via which the person can ask such questions, and then determines and provides answers to such questions.

In some embodiments, a Medivac 1000 may facilitate communication between a layperson and/or medical personnel at a remote location. As an example, it may communicate with an emergency medical technician at a remote location. Other examples are also possible.

When the multicopter arrives at the scene the multicopter may land, disable its rotors, and enter a mode where it functions as a communication interface via which a bystander could communicate with a live remote operator (e.g., a medical professional at a remote location), in order to receive instructions

Many other examples and variations on the above examples of Medivac 1000's with integrated medical-support systems and devices are also possible. For instance, a medical device may be integrated into the structure of itself when doing so reduces weight, improves aerodynamics, and/or simplifies the use of the device by a person at the scene of the medical situation.

It should be understood that the examples of medical-transport functionality that are provided herein are not intended to be limited. A Medivac 1000 may be configured to provide other types of medical-support functionality without departing from the scope of mission of safely transporting the patient.

Identifying a Remote Medical Situation

Various types of medical situations may be identified and instructions input from remote operators to identify the location where the Medivac 1000 will travel to. For example, a medical-support staff member could identify a medical situation and use an electronic touchpad or cell phone applications to dispatch the unit. Identification of the remote medical situation may involve a Medivac 1000 receiving a communication that originated from a remote device, and identifying the remote medical situation based on information provided by the communication. Such a communication may take various forms, such as a phone call, a text-message, or an electronic message generated by an application of a remote device, as just a few examples. In some embodiments, an automated computer program on a remote device may act as a notifier and initiate a communication to report a medical situation. For example, a body-monitoring device may detect a possible medical situation, such as a stroke or heart attack, and automatically notify a medical support system. Other examples are also possible.

In some embodiments, the communication may include location information, such as GPS coordinates of the remote device. Such location information may be utilized to determine the location of the remote device, which may in turn be assumed to be or otherwise used to determine the location of medical situation.

In some embodiments, the Medivac 1000 may obtain information from image data that is captured at the scene of a medical situation, which may then be used to determine what the particular medical situation is. Such image data may be captured by and/or sent from a remote device at the scene of the medical situation. In particular, a notifier may use the camera of their mobile phone to capture and send video and/or still images to the medical-support system, possibly in real-time. As examples, a bystander may capture an image or video of an injured limb, or possibly even video of an accident taking place, and such image data to the medical-support system. Other examples are possible.

Note that in some cases, the identification of the remote medical situation could simply involve the medical-support system receiving a communication that indicates what the medical situation is. In other words, the medical-support system may identify the medical situation by passively being told what it is by a remote device or by a human operator of the medical-support system (e.g., a live operator at access system for example.

Determining the Target Location

As noted above this involves a medical-support system determining a target location that corresponds to the identified medical situation. For example, when an emergency-response service is notified of a medical situation, the service will likely need to determine the general location of the person in need, so that a UAV can be deployed to assist the person.

The target location may be determined in a number of ways, and may be based on various types of location information. For instance, in some embodiments, the target location may be determined based on information that is provided by the remote device from which the indication of the medical situation was received. For example, consider a scenario where a bystander calls “911” and says “Somebody near me just collapsed!” Typically, when receiving a phone call, the police also receive location information, such as GPS coordinates, which identify the location of the remote device. This location information may then be made available to a medical-support system or otherwise accessible for purposes of determining the target location. For example, when a remote device calls to report a medical situation, an operator at an access system or an automated dispatch system could determine the location of the remote device based on such received GPS coordinates.

The above techniques for determining such target locations are provided for illustrative purposes and not intended to be limiting. It should be understood that other techniques may be used to determine a target location, to which a UAV may be dispatched by a medical-support system.

### Conclusion

Where example embodiments involve information related to a person or a device of a person, the embodiments should be understood to include privacy controls. Such privacy controls include, at least, anonymization of device identifiers, transparency and user controls, including functionality that would enable users to modify or delete information relating to the user's use of a product.

Further, in situations in where embodiments discussed herein collect personal information about users, or may make use of personal information, the users may be provided with an opportunity to control whether programs or features collect user information (e.g., information about a user's medical history, social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

The particular arrangements shown in the Figures should not be viewed as limiting. It should be understood that other embodiments may include more or less of each element shown in a given Figure. Further, some of the illustrated elements may be combined or omitted. Yet further, an exemplary embodiment may include elements that are not illustrated in the Figures.

We claim:

1. An autonomous operating medical evacuation drone for human transport, (MediVac Drone 1000 or “MVD”) a device with a computer-implemented method comprising: identifying by a processor a remote medical situation location; determining, by the processor, a target location corresponding to the identified remote medical situation; selecting, by the processor, the flight range of the drone (an unmanned aerial vehicle (UAV)) that is configured with automatic gyroscopic-based leveling technology, object avoidance driving technology, GPS location capability, embedded or integrated electrical battery and propeller motor based capacity to transport a person within a described weight and height ranges within optimum performance levels to another location with medical treatment capabilities. Electronic processor causes autonomous drone medivac unit to (a) travel to the target location in a forward-flight mode to the identified remote medical situation using cell-phone or other GPS location capability after receiving information from various ways, see #3. (b) transition to a hover flight mode when the patient is located at or near target landing location, and (c) land near the target person to provide medical transport evacuation services.

2. The method of claim 1, wherein identifying the remote medical situation comprises: receiving a communication that originated from a remote device; and identifying the remote medical situation location based on information provided by the communication.

3. The method of claim 2, wherein the communication comprises at least one of: (a) a phone call, (b) a text-message, and (c) an electronic message generated by an application of a remote device (d) inputted location data from a 911 operator, civilian, or military field personnel.

4. The method of claim 2, wherein the information provided by the communication comprises location information.

5. The method of claim 2, wherein determining the target location comprises receiving, from the remote device, a message that indicates the location of the remote device.

6. The method of claim 1, wherein selecting the UAV determining a distance, approx. capacity required to transport the patient of the medical situation.

7. The method of claim 6, wherein the medical-transport configuration comprises one or more items to provide transportation of said patient with or without added assistance from on-site personnel.

8. The method of claim 7, wherein the medivac drone uses low center of gravity design combined with gyroscopic auto-leveling technology combined with GPS location technology combined with instruction intake capability by mobile device, verbally or by input key pad manually. To provide location and travel instructions to the medical situation and then to another medical treatment location.

9. The method of claim 8, wherein the medical-evacuation service comprises a one or more operational functions to provide evacuation of the patient to another location away from the identified remote medical situation.

10. A non-transitory computer readable medium having stored therein instructions that are executable to cause a processor to perform functions comprising: identifying a remote medical situation; determining a target location corresponding to the remote medical situation;: (a) travel in a forward-flight mode to the target location to provide medical evacuation service for the identified remote medical situation person, (b) transition to a hover flight mode when the UAV is located at or near to the target location, and (c) while in the hover flight mode at or near to the target location, identify said patient location and land so as to allow for transport of said patient to another medical treatment location.
